(19) United States
(12) Patent Application Publication
(10) Pub. No.: US 2022/0287381 A1
(43) Pub. Date: Sep. 15, 2022

(54) CAR SEAT SWADDLE BLANKET SYSTEM

(71) Applicants: Dawn Thomas, Lethbridge (CA); Sandra DeGiano, Lethbridge (CA)

(72) Inventors: Dawn Thomas, Lethbridge (CA); Sandra DeGiano, Lethbridge (CA)

(21) Appl. No.: 17/830,216

(22) Filed: Jun. 1, 2022

Related U.S. Application Data
(63) Continuation-in-part of application No. 15/802,422, filed on Nov. 2, 2017, now abandoned.

(51) Int. Cl. A41B 13/06

(52) U.S. Cl. CPC A41B 13/06

(57) ABSTRACT

A car seat swaddle blanket system includes blanket having a body including a front-surface, a back-surface, an aperture, and a periphery comprising a first-edge, a second-edge, a third-edge, and a fourth-edge. The aperture exposes buckle fasteners and any clips on a car seat. The car seat swaddle blanket system may be removeably used for wrapping a baby in the car seat and allowing access to all of the buckle fasteners of the car seat via the aperture.

### RELATED APPLICATION(S)

This application is a continuation-in-part of U.S. patent application Ser. No. 15/802,422, filed Nov. 2, 2017, pending. This application is incorporated into this document by this reference.

### FIELD OF THE INVENTION

The present invention relates generally to the field of baby accessories and more specifically relates to a baby swaddle blanket.

### BACKGROUND

The following includes information that may be useful in understanding the present disclosure. It is not an admission that any of the information provided herein is prior art nor material to the presently described or claimed inventions, nor that any publication or document that is specifically or implicitly referenced is prior art.

The validity of car seat safety testing and the correct use of a car seat requires there be nothing between the baby and the seat back that wasn't part of the test procedure. Therefore, no aftermarket blankets or other accessories that intervene between the baby and the seatback are considered safe. Likewise, soft material such as blanket material that sits between the baby and the harness prevents the harness from being appropriately tightened. In an accident, inertial forces cause the soft material to be crushed by the baby's movement. Since the soft material isn't structurally equivalent to the harness material, the practical result is that the baby's body behaves as a too-loosely restrained body rather than a body restrained as the manufactured intended. For purposes of this disclosure “structurally safe” means that the device has a feature or multiple features that do not interfere with properly securing the baby in the seat while the device retains its intended use as a baby blanket. Alternatively, for purposes of this disclosure “structurally safe” means that the device does not have a feature that interferes with properly securing the baby in the seat while the device retains its intended use as a baby blanket. In this disclosure, “properly securing” means securing as the manufacturer directs and as suggested by the National Highway Traffic and Safety Administration (NHTSA) and American Academy of Pediatrics. For purposes of this disclosure “compositionally safe” means that the device is constructed to allow its intended use with a baby properly secured in a car seat without material of the device sitting between the baby and any harness straps. In this disclosure, “properly securing” means securing as the manufacturer directs and as suggested by the National Highway Traffic and Safety Administration (NHTSA) and American Academy of Pediatrics.

### DESCRIPTION OF RELATED ART

The United States and many other countries require the use of a car seat with a special restraint system for transporting children in a vehicle. Child car seat restraint systems restrain the child's torso in the car seat while leaving the head and limbs free to move naturally. In order to provide proper restraint, the restraining members must be tightly fitted to the child's torso. Typical swaddling blankets are also difficult to wrap around a baby, even when the baby is not confined to a car seat. A suitable solution is desired.

U.S. Pat. No. 8,118,364 to Margaret A. Davis relates to a blanket for placement upon an infant secured in a seat and method of use. The described blanket for placement upon an infant secured in a seat and method of use includes a travel blanket which is placed upon an infant in a car seat. The travel blanket has contoured sleeves and an open back construction, as well as stabilization means for securing the base section of the blanket onto an outer, exterior bottom portion of the seat. With these features, the travel blanket can be readily donned upon an infant that is buckled within a car safety seat without the need to adjust safety straps. The travel blanket includes a base section constructed with a base periphery integrated with the base stabilization means. Lateral sections of the travel blanket further include lateral perimeters appointed for aiding in securing the lateral sections over the infant, without wrapping the torso of the infant. Contoured arm sleeves provide enhanced safety to infants. The sleeves snuggly fit over the infant's wrists and do not have loose flowing material about the arms and wrists which could present a suffocation risk. Construction of the travel blanket ensures a significant amount of coverage over the entire body of the infant that does not contribute to shifting, zero wrapping of the infant's body/torso, and minimal jostling of the infant when applied.

5,950,261, Hey et al. is directed to a blanket wrap tailored to mount to a car seat or infant carrier. Safety restraints at the support mount through the wrap to permit attachment of the straps to the infant or toddler prior to fitting the wrap to the infant. An integral cushioned pad is centered to the wrap and fasteners are arrayed about the wrap to assure a snug fitting, once the infant is strapped to the seat or carrier. A hood and sleeves can be provided at the wrap. Apparently, this device would not be expected by those of ordinary skill in the art to meet the structurally safe definition set out above. In that regard, this reference cannot properly be regarded as analogous art because it allows uses of its device in such a way as to flout safety suggestions.

D477,744, Kelly is a design of a baby blanket. Apparently, this device would not be expected by those of ordinary skill in the art to meet the structurally safe definition set out above. In that regard, this reference cannot properly be regarded as analogous art because it allows uses of its device in such a way as to flout safety suggestions. Likewise, this device would not be expected by those of ordinary skill in the art to meet the compositionally safe definition set out above. In that regard, this reference cannot properly be regarded as analogous art because it allows uses of its device in such a way as to flout safety suggestions.

US20050150047, Trani et al. is directed to a swaddling blanket for easily and swiftly swaddling an infant keeps the infant tightly bundled for security and warmth. This blanket helps calm the infant and prevents the infant from being awakened from the startling response. Safety and emotional well-being are thus promoted for both the infant and the parent. The infant looks cute and loveable when wrapped in this blanket The blanket may be made of cotton fabric material and may be tied or tucked for size and tightness adjustments without the use of added fasteners. Apparently, this device would not be expected by those of ordinary skill in the art to meet the structurally safe definition set out above. In that regard, this reference cannot properly be regarded as analogous art because it allows uses of its device in such a way as to flout safety suggestions. Likewise, this device would not be expected by those of ordinary skill in the art to meet the compositionally safe definition set out above. In that regard, this reference cannot properly be regarded as analogous art because it allows uses of its device in such a way as to flout safety suggestions.

### BRIEF SUMMARY OF THE INVENTION

In view of the foregoing disadvantages inherent in the known baby accessory art, the present disclosure provides a novel car seat swaddle blanket system. The general purpose of the present disclosure, which will be described subsequently in greater detail, is to provide an infant swaddle blanket having an aperture for allowing a user to access car seat buckles.

A car seat swaddle blanket system is disclosed herein. The car seat swaddle blanket system includes a blanket having a body comprising a front-surface, a back-surface, an aperture, and a periphery comprising a first-edge, a second-edge, a third-edge, and a fourth-edge. The blanket includes the body defined by the periphery. The body is further defined by the front-surface and the back-surface opposing each other and integral with each other, the back-surface in contact with a car seat when in use during an in-use condition. The periphery comprises the first-edge, the second-edge, the third-edge, and the fourth-edge, respectively; the first-edge is positioned proximal to a top of the car seat, the second-edge is positioned proximal to a right-side of the car seat, the third-edge is positioned proximal to a bottom of the car seat, and the fourth edge is positioned proximal to a left-side of the car seat during the in-use condition. The aperture is located substantially in a center of the body and is configured to receive buckle fasteners of the car seat. The car seat swaddle blanket system may be removeably used for wrapping a baby in the car seat and allowing access to all of the buckle fasteners of the car seat.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a car seat swaddle blanket system, constructed and operative according to the teachings of the present disclosure.

FIG. 1 is a front perspective view of the car seat swaddle blanket system during an ‘in-use’ condition, according to an embodiment of the disclosure.

FIG. 2 is a perspective view of the car seat swaddle blanket system of FIG. 1, according to an embodiment of the present disclosure.

FIG. 3 is a perspective view of the car seat swaddle blanket system of FIG. 1, according to an embodiment of the present disclosure.

FIG. 4 is a perspective view of the car seat swaddle blanket system of FIG. 1, according to an embodiment of the present disclosure.

FIG. 5 is a perspective view of the car seat swaddle blanket system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a baby accessory and more particularly to a car seat swaddle blanket system as used to improve the baby swaddle blanket.

Generally, the car seat swaddle blanket system is a backless swaddle blanket designed to meet safety standards for infant seats. The present invention includes a swaddle blanket which can be removed from the baby and seat without removing the baby from the seat. It can also be put on the baby while the baby is in the car seat. It is designed for an infant bucket car seat. The device prevents a child from kicking the blanket away on to the floor.

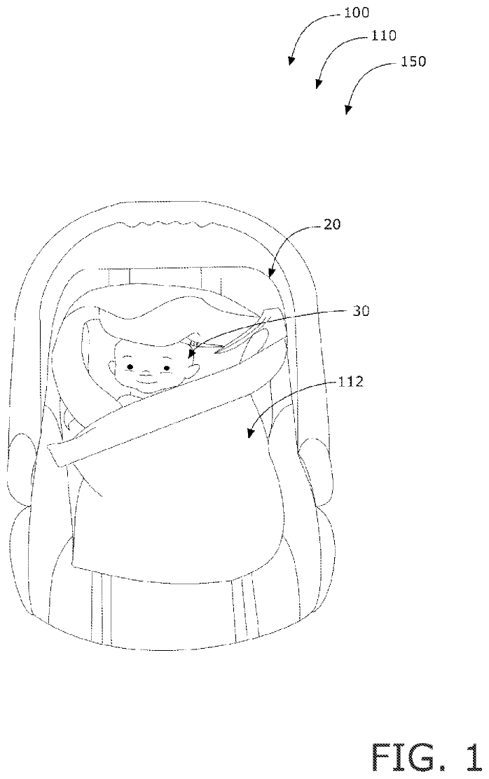

Referring now more specifically to the drawings by numerals of reference, there is shown in FIGS. 1-5, various views of a car seat swaddle blanket system 100. FIG. 1 shows a car seat swaddle blanket system 100 during an ‘in-use’ condition 150, according to an embodiment of the present disclosure. As illustrated, the car seat swaddle blanket system 100 may include a blanket 110 having a body 112 comprising a front-surface 116, a back-surface 118, an aperture 120, and a periphery 124 comprising a first-edge 126, a second-edge 128, a third-edge 130, and a fourth-edge 132. The device may be used for swaddling a baby and providing access to buckle fasteners 10 of a car seat 20.

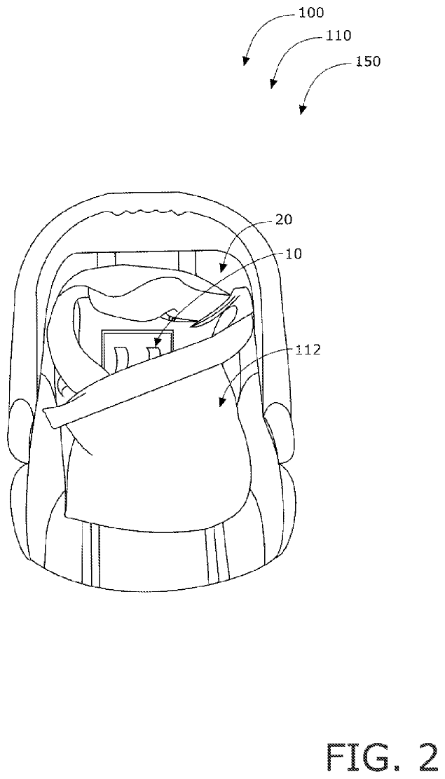

FIG. 2 shows a perspective view of the car seat swaddle blanket system 100 of FIG. 1, according to an embodiment of the present disclosure. As above, the car seat swaddle blanket system 100 may include the blanket 110 having the body 112 defined by the periphery 124. The body 112 is further defined by the front-surface 116 and the back-surface 118 opposing each other and integral with each other. The back-surface 118 is in contact with the car seat 20 when in use during an in-use condition. The periphery 124 comprises the first-edge 126, the second-edge 128, the third-edge 130, and the fourth-edge 132, respectively. The first-edge 126 is positioned proximal to a top of the car seat 20, the second-edge 128 is positioned proximal to a right-side of the car seat 20, the third-edge 130 is positioned proximal to a bottom of the car seat 20, and the fourth edge 132 is positioned proximal to a left-side of the car seat 20 during the in-use condition.

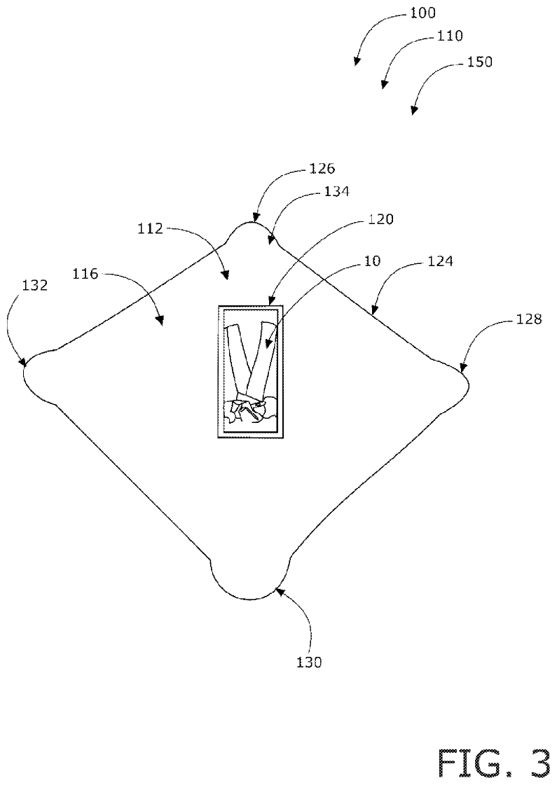

FIG. 3 shows a perspective view of the car seat swaddle blanket system 100 of FIG. 1, according to an embodiment of the present disclosure. As above, the car seat swaddle blanket system 100 may include the blanket 110 having the body 112 comprising the front-surface 116, the back-surface 118, the aperture 120, and the periphery 124. The aperture 120 comprises a substantially rectangular profile or other suitable shape for exposing the buckle fasteners 10 and any clips or straps for a car seat 20. The buckle fasteners 10 are exposed during the in-use condition. The aperture 120 is configured to provide access to all of the buckle fasteners 10 and straps of the car seat. The blanket 110 may comprise a flexible fabric for wrapping a baby. The aperture 120 is located in a center of the body 112 and is configured to receive buckle fasteners 10 of the car seat 20. The car seat swaddle blanket system 100 may be removeably used for wrapping a baby 30 in the car seat 20 and allowing access to all of the buckle fasteners of the car seat 20.

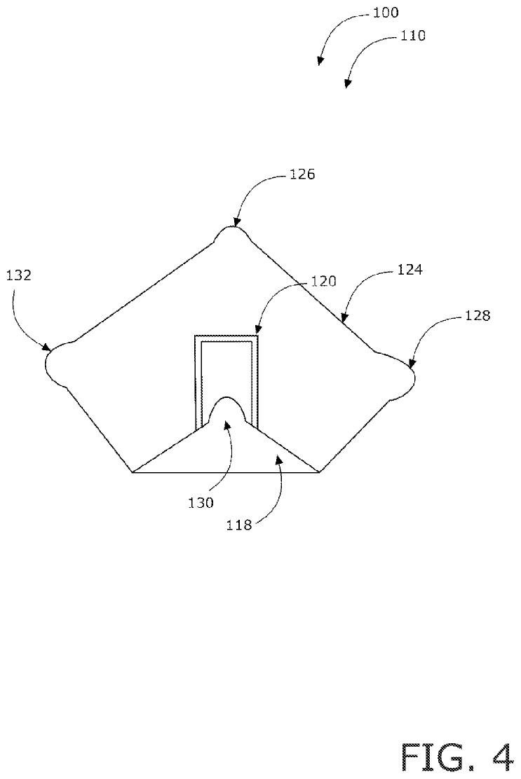

FIG. 4 shows a perspective view of the car seat swaddle blanket system 100 of FIG. 1, according to an embodiment of the present disclosure. In a preferred embodiment, the aperture 120 may comprise an aperture-width of approximately 5 inches and an aperture-length of approximately 14.5 inches. A distance from an outer edge of the aperture 120 to the third-edge 130 is approximately 18 inches. A distance from an outer edge of the aperture 120 to the first-edge 126 is approximately 15.5 inches. A length from the aperture 120 to the second-edge 128, and the aperture 120 to the fourth-edge 132 are each respectively approximately 21.5 inches. The body 112 has a body-length and body-width of approximately 48.5 inches. Other dimensions may be used in alternate embodiments.

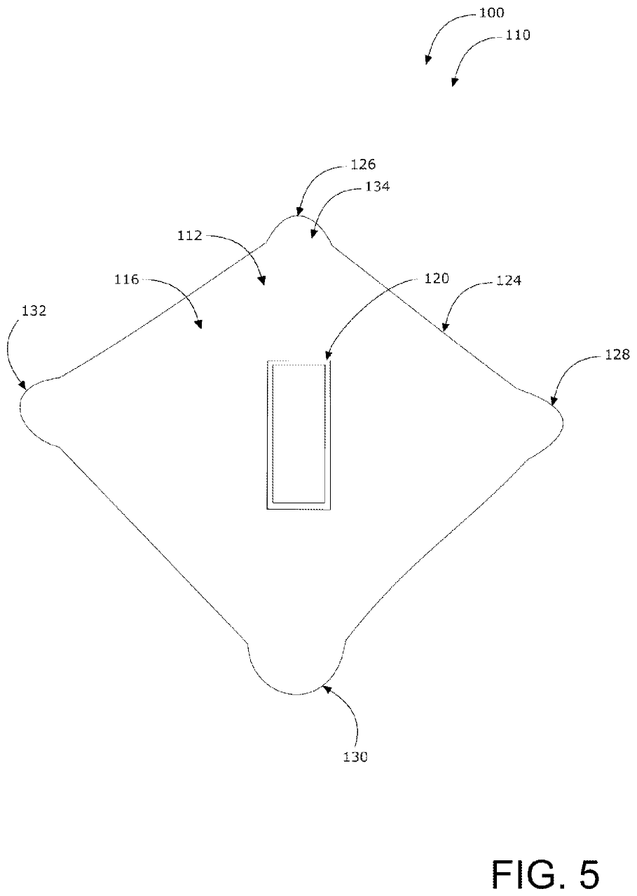

FIG. 5 shows a perspective view of the car seat swaddle blanket system 100 of FIG. 1, according to an embodiment of the present disclosure. As above, the car seat swaddle blanket system 100 may include the blanket 110 having the body 112 comprising the front-surface 116, the back-surface 118, the aperture 120, and the periphery 124 comprising the first-edge 126, the second-edge 128, the third-edge 130, and the fourth-edge 132. The first-edge 126, the second-edge 128, the third-edge 130, and the fourth-edge 132 each comprise a flap 134. The flap 134 comprises a rounded apex further extending the first-edge 126, the second-edge 128, the third-edge 130, and the fourth-edge 132 from the body 112. The second-edge 128 and the fourth-edge 132 are opposing one another in a planar, non-folded-condition. The first-edge 126 and the third-edge 130 are also opposing one another in the planar, non-folded-condition. The third-edge 130 is configured to be folded upwardly towards the first-edge 126 to wrap the baby within. The fourth-edge 132 is configured to be folded inwardly towards the second-edge 128 and the second-edge 128 is configured to be folded inwardly towards the fourth-edge 132. The device may be used as shown in the present FIGS. 1-5 and as disclosed herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A blanket comprising:
a body with a front-surface, a back-surface, an aperture, and
a periphery having a first-edge, a second-edge, a third-edge, and
a fourth-edge,
wherein the back-surface contacts a car seat during an in-use condition.

2. The blanket of claim 1, wherein the blanket is structurally safe.

3. The blanket of claim 2, wherein the aperture provides a structurally safe feature.

4. The blanket of claim 3, wherein the aperture is configured to receive buckle fasteners of the car seat.

5. The blanket of claim 4, wherein the blanket is configured to be removed from the car seat without removing a car seat occupant from the blanket.

6. The blanket of claim 5, wherein the aperture comprises a substantially rectangular profile.

7. The blanket of claim 6, wherein the aperture comprises a width selected to provide structurally safe contact between the car seat and a car seat occupant.

8. The blanket of claim 7, wherein the width is 4 or more inches.

9. The blanket of claim 8, wherein the aperture comprises a length selected to provide structurally safe contact between the car seat and a car seat occupant.

10. The blanket of claim 9, wherein the length is 10 or more inches.

11. The blanket of claim 10, wherein the aperture is configured to provide access to the buckle fasteners of the car seat, the buckle fasteners are exposed during the in-use condition.

12. The blanket of claim 2, wherein the second-edge and the fourth-edge are opposing one another in a planar, non-folded condition.

13. The blanket of claim 12, wherein the first-edge and the third-edge are opposing one another in the planar, non-folded condition.

14. The blanket of claim 13, wherein the third-edge is configured to be folded upwardly towards the first-edge to wrap a car seat occupant within.

15. The blanket of claim 14, wherein the fourth-edge is configured to be folded inwardly towards the second-edge to wrap the car seat occupant within.

16. The blanket of claim 15, wherein the second-edge is configured to be folded inwardly towards the fourth-edge to wrap the car seat occupant within.

17. The blanket of claim 16, wherein the blanket is compositionally safe.
